(19) United States
(12) Patent Application Publication
(10) Pub. No.: US 2015/0227510 A1
(43) Pub. Date: Aug. 13, 2015

(54) SYSTEM FOR SPEAKER DIARIZATION BASED MULTILATERAL AUTOMATIC SPEECH TRANSLATION SYSTEM AND ITS OPERATING METHOD, AND APPARATUS SUPPORTING THE SAME

(71) Applicant: ELECTRONICS AND TELECOMMUNICATIONS RESEARCH INSTITUTE, Daejeon (KR)

(72) Inventors: Jong Hun SHIN, Daejeon (KR); Ki Young LEE, Daejeon (KR); Young Ae SEO, Daejeon (KR); Jin Xia HUANG, Daejeon (KR); Sung Kwon CHOI, Daejeon (KR); Yun JIN, Daejeon (KR); Chang Hyun KIM, Daejeon (KR); Seung Hoon NA, Daejeon (KR); Yoon Hyung ROH, Daejeon (KR); Oh Woog KWON, Daejeon (KR); Sang Keun JUNG, Daejeon (KR); Eun Jin PARK, Daejeon (KR); Kang Il KIM, Daejeon (KR); Young Kil KIM, Daejeon (KR); Sang Kyu PARK, Daejeon (KR)

(73) Assignee: ELECTRONICS AND TELECOMMUNICATIONS RESEARCH INSTITUTE, Daejeon (KR)

(21) Appl. No.: 14/607,814

(22) Filed: Jan. 28, 2015

(30) Foreign Application Priority Data
Feb. 7, 2014 (KR) 10-2014-0014318

(51) Int. Cl. G06F 17/28; G10L 15/00

(52) U.S. Cl. CPC G06F 17/289; G10L 15/005

(57) ABSTRACT

The present invention relates to a translation function and discloses an automatic translation operating device, including: at least one of voice input devices which collects voice signals input by a plurality of speakers and a communication module which receives the voice signals; and a control unit which controls to classify voice signals by speakers from the voice signals and cluster the speaker based voice signals classified in accordance with a predefined condition and then perform voice recognition and translation and a method thereof and a system including the same.

### CROSS-REFERENCE TO RELATED APPLICATIONS

This application claims priority to and the benefit of Korean Patent Application No. 10-2014-0014318 filed in the Korean Intellectual Property Office on Feb. 7, 2014 the entire contents of which are incorporated herein by reference.

### TECHNICAL FIELD

The present invention relates to an automatic translation system and method which may be used based on a portable computing terminal such as a smart phone or a computing device including a voice input device such as a microphone, and an apparatus supporting the same.

### BACKGROUND ART

A mobile communication terminal which is carried and used by a user may support an automatic translation function which translates a source language input by the user into a target language. A source language input method may include a method which directly inputs a text using an input device of the terminal, for example, a keyboard by a user and a voice input method. The voice which is input by the voice input method may be converted into a corresponding text through a voice recognizing system.

In the meantime, the user mainly uses a portable terminal such as a smart phone or uses a PC or mobile personal computer sometimes in order to perform multilateral and one to one conversation. During this process, the user may use the above-mentioned automatic translation (interpretation). A technology which is generally used in this process is configured to achieve one to one interaction between a main user and another user. That is, a voice recognizing unit (or a voice recognizing sub system) obtains voice data which is uttered by one speaker through a voice input device such as a microphone at one time, converts the input voice into a text to transmit the text to an automatic translation system and finally outputs a text which is configured by translated languages, that is, a translation result.

As described above, according to an automatic translation function of the related art, the speaker needs to utter once and mandatorily perform the interaction with a user interface of the service so that manipulation of a screen of the terminal or a hardware button by hands or manipulation of tilting the device needs to be necessarily accompanied. Further, according to the automatic translation function of the related art, a behavior for searching a voice recognition result or a translation result or correcting setting information of a source language or a translated language needs to be necessarily accompanied, which may cause inconvenience for the user. Further, the automatic translation function of the related art requires to obtain an uttering authority during a service providing process, which may cause a situation when a stream of the conversation is cut off (a situation when another speaker interrupts while the speaker talks). Further, when the stream of the conversation is cut off, a correct voice recognition result may not be obtained and thus an incorrect translation result is highly likely to be output.

### SUMMARY

The present invention has been made in an effort to provide a speaker diarization based multilateral automatic translation operating system and method which may minimize communication delay and a translation error problem while operating an automatic translation function and an apparatus supporting the same.

The present invention has also been made in an effort to provide a speaker diarization based multilateral automatic translation operating system and method which minimize an interacting process between a user and a machine to operate an automatic translation function through more simple manipulation and an apparatus supporting the same.

An exemplary embodiment of the present invention provides an automatic translation operating device, including: at least one of voice input devices which collects voice signals input by a plurality of speakers and a communication module which receives the voice signals; and a control unit which controls to classify voice signals from the voice signal by speakers and cluster the speaker based voice signals classified in accordance with a predefined condition and then perform voice recognition and translation.

The control unit may classify the voice signals by speakers using the voice input device which collects the voice signals and electronic devices which transmit the voice signals as indexes.

The control unit may perform learning for distinguishing a voiceprint per speaker.

When a voice signal of the voiceprint other than a speaker who is distinguished in advance is input, the control unit may determine the speaker as a new speaker.

The control unit may perform clustering until a sentence termination ending or a sentence termination code is searched in the speaker based voice signal.

The control unit may perform translation on a complete sentence which is distinguished by the sentence termination ending or the sentence termination code.

The device may further include a display module which outputs the speaker based voice recognition and translation result.

The control unit may convert a translation result corresponding to a specific voice signal designated among the speaker based voice signals into an audio signal.

The device may further include an audio module which outputs the audio signal.

Another exemplary embodiment of the present invention provides an automatic translation operating method, including: collecting voice signals which are input by a plurality of speakers; classifying the voice signals by speakers from the voice signals; clustering the speaker based voice signal which is classified in accordance with a predefined condition; and recognizing and translating the clustered voice signals as a voice.

The collecting may include collecting the voice signals using at least one of voice input devices and a communication module.

The classifying may include classifying the voice signals by speakers using the voice input device which collects the voice signals and electronic devices which transmit the voice signals as indexes.

The method may further include performing learning for distinguishing a voiceprint per speaker.

The classifying may include when a voice signal of the voiceprint other than that of a speaker who is distinguished in advance is input, determining the speaker as a new speaker.

The clustering may include: searching a sentence termination ending or a sentence termination code in the speaker based voice signal; and recognizing a section where the sentence termination ending or the sentence termination code is searched as a complete sentence.

The translating may include performing translation on a complete sentence which is distinguished by the sentence termination ending or the sentence termination code.

The method may further include outputting the speaker based voice recognition and translation result.

The method may further include: converting a translation result corresponding to a specific voice signal designated among the speaker based voice signals into an audio signal; and outputting the audio signal.

Yet another exemplary embodiment of the present invention provides an automatic translation operating system, including: a plurality of electronic devices which collects and transmits voice signals input by a plurality of speakers; and an automatic translation operating device which controls to classify voice signals by speakers from the voice signals transmitted by the electronic devices and cluster the speaker based voice signals classified in accordance with a predefined condition and then perform voice recognition and translation.

The automatic translation operating device may perform the clustering until a sentence termination ending or a sentence termination code is searched in the speaker based voice signal and recognize, translate, and output the clustered signals as a voice.

As described above, according to the speaker diarization based multilateral automatic translation operating system, method, and the apparatus supporting the same, the present invention may distinguish uttered contents through speaker recognition/separation without having complicated interaction with a user interface when the translation is automatically performed, and selectively listen to or watch the uttered contents.

According to the exemplary embodiment of the present invention, the user may easily obtain a translation result through less interface interaction, which is different from the related art.

The exemplary embodiment of the present invention may assist to utilize the automatic translation system in a multilateral conference or a situation when people need to concentrate on the conversation.

The present invention may improve a quality of a moubtable automatic translation service and applications which are used for the multilateral conversation.

### BRIEF DESCRIPTION OF THE DRAWINGS

FIG. 1 is a view schematically illustrating a configuration of a multilateral automatic translation supporting system according to an exemplary embodiment of the present invention.

FIG. 2 is a view schematically illustrating a configuration of an automatic translation operating device which supports a multilateral automatic translation function according to an exemplary embodiment of the present invention.

FIG. 3 is a view illustrating a speaker diarization processing according to an exemplary embodiment of the present invention.

FIG. 4 is a view illustrating a clustering operation per speaker according to an exemplary embodiment of the present invention.

FIG. 5 is a view illustrating an example of a screen interface of an automatic translation operating device according to an exemplary embodiment of the present invention.

FIG. 6 is a diagram illustrating a multilateral automatic translating method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, various exemplary embodiments of the present invention will be described in detail with reference to accompanying drawings. In this case, it should be noted that like components are denoted by like reference numerals in the accompanying drawings. When it is determined that a detailed description of publicly known functions and configurations may obscure the gist of the present invention, the detailed description thereof will be omitted. In other words, it should be noted that only parts required to understand an operation according to the exemplary embodiment of the present invention will be described below and a description of other parts will be omitted so as not to cloud the gist of the present invention.

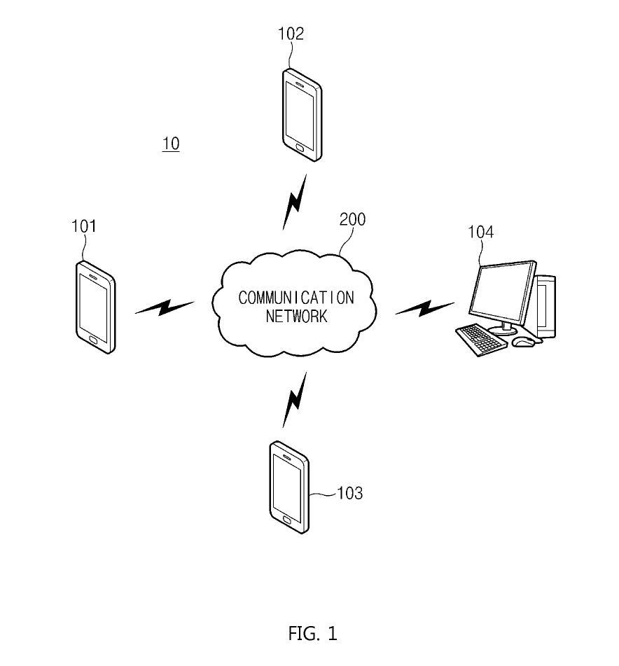

FIG. 1 is a view schematically illustrating a configuration of a multilateral automatic translation supporting system according to an exemplary embodiment of the present invention.

Referring to FIG. 1, a multilateral automatic translation supporting system 10 according to an exemplary embodiment of the present invention may include a plurality of electronic devices 101, 102, and 103, an automatic translation operating device 104, and a communication network 200.

In the multilateral automatic translation supporting system 10 with this configuration, when voice signals collected by the plurality of electronic devices 101, 102, and 103 are transmitted to the automatic translation operating device 104 through the communication network 200, the automatic translation operating device 104 may classify the plurality of voice signals for each speaker, cluster the classified voice signals, and translate the clustered voice signals.

The plurality of electronic devices 101, 102, and 103 collects user voice signals to transmit the voice signals to the automatic translation operating device 104 through the communication network 200. To this end, the plurality of electronic devices 101, 102, and 103 may serve as a voice input device. Such a plurality of electronic devices 101, 102, and 103 may be portable terminals. Alternatively, the plurality of electronic devices 101, 102, and 103 may be desktop terminals. In the meantime, the plurality of electronic devices 101, 102, and 103 may be used as automatic translation operating devices depending on a setting or a design method. The plurality of electronic devices 101, 102, and 103 may receive and output at least one of a voice recognition result or a translation result from the automatic translation operating device 104.

When voice signals of plural speakers are received through at least one voice input device, the automatic translation operating device 104 may classify the voice signals per speaker and cluster the classified voice signals. Further, the automatic translation operating device 104 may translate the clustered voice signals. Further, the automatic translation operating device 104 may output or transmit the translation result to the plurality of electronic devices 101, 102, and 103. In the meantime, a voice input device is provided in the automatic translation operating device 104 to collect user voice signals. Further, the automatic translation operating device 104 may translate and transmit the collected voice signals.

The communication network 200 may form a communication channel through which voice signals are transmitted and received between the plurality of electronic devices 101, 102, and 103. Such a communication network 200 may be configured by communication modules which may form a wireless communication channel or communication modules which may form a wired communication channel. That is, the communication network 200 according to an exemplary embodiment of the present invention may transmit the plurality of voice signals which is collected by the voice input device to the automatic translation operating device 104 under a circumstance where voice input devices which may collect voice signals of a plurality of users are provided. Further, the communication network 200 may transmit the result which is translated by the automatic translation operating device 104 to the plurality of electronic devices 101, 102, and 103. When the communication network 200 is provided in the form of a wireless communication channel, each of the plurality of electronic devices 101, 102, and 103 and the automatic translation operating device 104 may include a communication module which may perform remote communication based on a base station. Further, when the communication network 200 is a network which is formed of a wireless communication channel, the plurality of electronic devices 101, 102, and 103 and the automatic translation operating device 104 may include a communication module which may perform local area communication, for example, Bluetooth communication.

As described above, at least one of the plurality of electronic devices 101, 102, and 103 may function as the automatic translation operating device 104. The automatic translation operating device 104 may support translation into a set language. As a result, according to the multilateral translation supporting system 10 according to the exemplary embodiment of the present invention, speakers of the plurality of electronic devices 101, 102, and 103 or the automatic translation operating devices 104 may share the voice signals which are uttered by the speakers and the devices may receive a signal in which the voice signals which are uttered by plural speakers overlap. During this process, the multilateral automatic translation supporting system 10 according to the exemplary embodiment of the present invention classifies the voice signals of the plurality of speakers by speakers and clusters the classified voice signals to perform translation when a predetermined condition is satisfied.

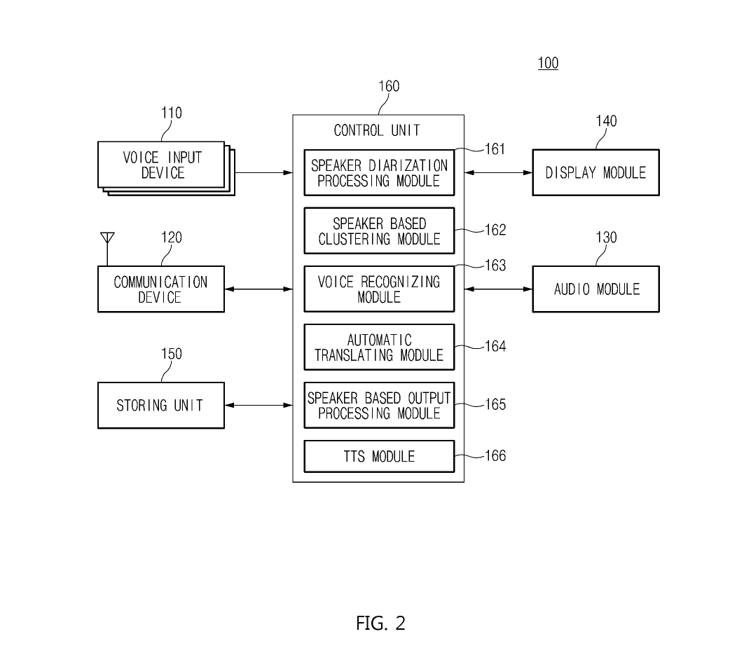

In the meantime, an example in which the multilateral automatic translation system according to the exemplary embodiment of the present invention is configured based on the plurality of electronic devices 101, 102, and 103 is suggested, but the present invention is not limited thereto. That is, one automatic translation operating device 104 may include a plurality of voice input devices and classify voice signals of speakers which are input from the plurality of voice input devices by speakers and cluster the voice signals and then translate the voice signals. This will be described in more detail with reference to FIG. 2.

FIG. 2 is a view schematically illustrating a configuration of an automatic translation operating device which supports a multilateral automatic translation function according to an exemplary embodiment of the present invention. As described above, the automatic translation operating device according to the exemplary embodiment of the present invention may configured as various types such as a portable terminal or a desktop type terminal. Therefore, the automatic translation operating device is denoted by reference numeral 100 and the electronic devices and the translation operating function of the automatic translation operating device which have been described with reference to FIG. 1 will be described hereinbelow.

Referring to FIG. 2, an automatic translation operating device 100 according to an exemplary embodiment of the present invention may include a voice input device 110, a communication module 120, an audio module 130, a display module 140, a storing unit 150, and a control unit 160.

The automatic translation operating device 100 with this configuration may include a plurality of voice input devices 110, classify and cluster collected voice signals of a plurality of speakers by speakers and then perform translation when a predetermined condition is satisfied. By doing this, even though the plurality of speakers simultaneously utters, the automatic translation operating device 100 according to an exemplary embodiment of the present invention may exactly recognize the speakers and voice and thus support an exact translation service thereby.

The voice input device 110 may receive voice signals from a single voice input device (for example, a microphone) or a plurality of voice input devices. A sort of pre-processing (for example, a job of combining PCM data which is input from a plurality of voice input devices in the order of time to extend/replace insufficient strength of the voice signal) is performed on the voice signal which is received by the voice input device 110 and the voice signal is transmitted to a speaker diarization processing module 161 of the control unit 160. After performing the above-described other settings, a user utilizes the system to perform automatic translation. During this process, the voice is generally input using a microphone which is mounted in a portable computing device such as a smart phone and an application of the system may expand a voice input channel (device). To this end, the voice input device 110 according to an exemplary embodiment of the present invention may combine multiple microphone inputs through a plurality of microphone and audio mixers to mix down the inputs in one channel to be transmitted to the control unit 160.

The communication module 120 may receive a plurality of voice signals. For example, the communication module 120 may form an encrypted Wi-Fi access point (AP) based communication channel or a subnet of a specific network. According to the exemplary embodiment of the present invention, electronic devices which belong to the subnet of the specific network form a pair to group a plurality of portable computing devices such as smart phones. When a user permits to use devices which access the same subnet, identification information of the user is transmitted to group devices which are to perform the translation service of the exemplary embodiment of the present invention. The voice PCM data which is provided from the plurality of grouped electronic devices may be received through the communication module 120 and the communication module 120 may provide the voice PCM data to the control unit 160. The control unit 160 synchronizes the voice PCM data at a time when a delta difference for a pseudo PCM section (PCM data which is uttered at a pseudo time with respect to a time axis) is minimized, to strength the voice PCM data. For example, when the communication module 120 is a Bluetooth module, the plurality of electronic devices performs a pairing process and the electronic devices collect and transmit the voice input. In this case, the control unit 160 combines the voice signals whose delta difference for the pseudo PCM section is minimized to amplify or replace the signal to be synchronized, thereby strengthening the voice PCM data.

The audio module 130 may output an audio signal of the automatic translation operating device 100. Specifically, the audio module 130 may output data which is classified by speakers and then translated as a specific voice under the control of the control unit 160. For example, under the circumstances where a plurality of speakers utters, a voice signal of a specific speaker which is designated in the automatic translation operating device 100 is translated into another language and then output as a specific voice through the audio module 130. Here, the specific speaker may be designated by an input unit of the automatic translation operating device 100. For example, the automatic translation operating device 100 may output information on the speakers as a list under a multilateral call circumstance. Further, when a specific speaker is selected among speakers which are included in the list by the input signal, the automatic translation operating device 100 may output a voice signal of the speaker through the audio module 130. Here, the audio module 130 may output a voice signal of a specific speaker which is translated by a language which is set by a user of the automatic translation operating device 100. Further, the audio module 130 may simultaneously output voice signals of the plurality of speakers in accordance with the setting. Alternatively, the audio module 130 may output a plurality of translated voice signals which is obtained by translating the voice signals of the plurality of speakers in accordance with the setting.

The display module 140 may output various screens related with performing of a function of the automatic translation operating device 100. For example, the display module 140 may output a function waiting screen for performing a translating function and a screen for collecting a voice signal which is input by the plurality of speakers as the function is performed. Further, the display module 140 may output a screen in which collected voice signals are classified by speakers, a screen of a result of recognizing a voice signal per speaker as a voice, and a screen which outputs the voice recognition result which is translated into a specific language. In the meantime, the display module 140 may output a screen for performing a specific function of the automatic translation operating device 100, for example, a menu item for performing a translation operating function or an idle screen on which icons are disposed. Further, the display module 140 may output a screen regarding formation of a communication module 120 based communication channel, for example, a Bluetooth based local area communication channel and a screen which outputs a list of electronic devices which forms a communication network as the local area communication channel is formed. A screen interface for operating the translation through the above-described display module 140 will be described in more detail below with reference to the drawing which will be described below.

The storing unit 150 may store various programs and data require to perform the function of the automatic translation operating device 100. For example, the storing unit 150 may store an operating system for operating the device of the automatic translation operating device 100 and a program for performing a specific user function, for example, a music playing function, a broadcasting receiving function, and a call function. Specifically, the storing unit 150 may store the translation operating program. The translation operating program may include a program routine for operating at least one voice input device 110 and a program routine for operating the communication module 120. Further, the translation operating program may include a routine of classifying the collected voice signals by speakers, a routine of clustering the voice signals which are classified by the speakers based on a predetermined condition, a routine of recognizing the clustered result as a voice, a routine of translating the voice recognized result into a preset language, and a routine of outputting at least one of the voice recognized result and a translation result on at least one of the display module 140, the audio module 130, and the communication module 120. The above-mentioned routines may be loaded in the control unit 160 to perform functions related with the translation operating. In the meantime, the above-mentioned routines may be provided in a various types such as hardware, software, and middleware.

The control unit 160 may control to process a signal regarding supporting of a translating function of the automatic translation operating device 100, and process and transmit data. Such a control unit 160 may include a speaker diarization processing module 161, a speaker based clustering module 162, a voice recognizing module 163, an automatic translating module 164, a speaker based output processing module 165, and a TTS module 166.

The control unit 160 including the above-mentioned components may first support to set its own language. A language setting step is a step of determining a language to be translated which is transmitted to a user and may be a step of setting a language to be translated based on the automatic translating module 164. When an own-language setting step is not set, the control unit 160 controls to transmit the voice PCM data which is generated when the user utters to the voice recognizing module 163 to convert the voice PCM data into a text and output the text only on the display module 140 through the speaker based output processing module 165. During this process, a translating process of the voice PCM data by the automatic translating module 164 may be omitted. When the language is set, the control unit 160 may control to translate the voice signals which are input by other speakers into a set language and output the translated voice signals.

The speaker diarization processing module 161 obtains the voice PCM data to perform speaker diarization. In this case, the speaker diarization processing module 161 assigns an arbitrary unique ID to a diarized result to transmit the result to the speaker based clustering module 162.

In the meantime, the user may perform user voice learning based on the speaker diarization processing module 161 and the speaker based clustering module 162. For the voice learning, the speaker diarization processing module 161 may induce the user to utter a predetermined number of sentences, for example, a text including approximately ten sentences. When the user voice signal is collected in accordance with the learning, the speaker diarization processing module 161 may extract and store a voiceprint (a specific characteristic of a voice like a fingerprint of finger) of the user. Thereafter, when voice PCM data which is similar to that of the user is input, the speaker based clustering module 162 may classify the voice PCM data as a user and change a data processing path so as to support the designated various settings, for example, a voice translation based result output or a voice recognition based result output.

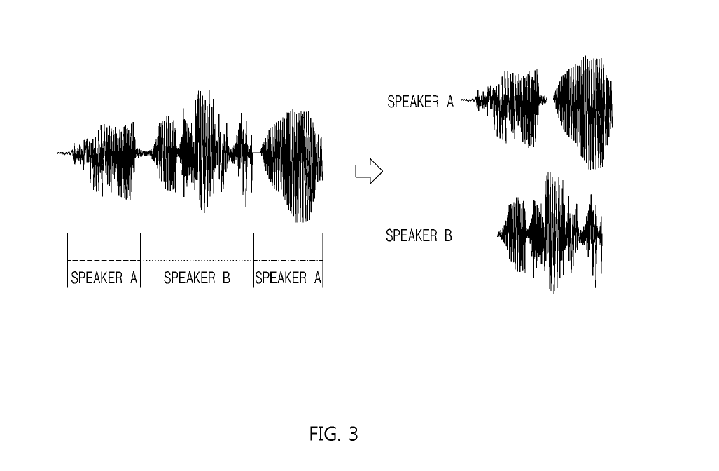

When the voice signal is collected by at least one of the voice input devices 110 and the communication module 120, the speaker diarization processing module 161 allocates a predetermined amount of voice PCM input buffer and when a significant amount of voice PCM data which is collected in the buffer is accumulated, performs the speaker diarization. A result in accordance with the speaker diarization may be returned such that a unique ID (for example, UUID) is assigned to each of the identified speakers together with a frame of the designated voice PCM data. Further, when the speaker is switched, the speaker diarization processing module 161 may return whether the speaker is switched in the frame. The speaker diarization processing module 161 may classify a unique ID for every main user which is already learned or generate a separate ID for an unknown new speaker to support the identification of the new speaker. That is, the speaker diarization processing module 161 may return the result as illustrated in FIG. 3.

FIG. 3 is a view illustrating a speaker diarization processing according to an exemplary embodiment of the present invention.

Referring to FIG. 3, when single channel voice PCM data is received, the speaker diarization processing module 161 according to the exemplary embodiment of the present invention divides the voice PCM data in accordance with the voice input signal and the speaker diarization result and then returns the voice PCM data together with the user ID (here, a speaker A and a speaker B).

The speaker based clustering module 162 may combine the voice PCM data which is classified by speakers. In this case, the speaker diarization processing module 161 may transmit information on a time when the speaker is switched together with an indirect voice signal (a pause blank voice signal at which no uttering is performed) to the speaker based clustering module 162. When a voice uttering pause section or a time when the speaker is completely switched is detected, the speaker based clustering module 162 may transmit the voice PCM data which is previously combined to the voice recognizing module 163. The voice PCM data is segmented with a specific length (time or frame) which is defined in advance to be transmitted to the speaker based clustering module 162. The speaker based clustering module 162 may gather the received voice PCM data with the unique ID which is assigned to every speaker and continuously combine the voice PCM data until a predetermined length (time or frame) or a condition which is designated in the system is satisfied. In this case, an available condition may be a case when voice PCM data of the speaker is accumulated for a time (for example, ten seconds) which is designated in the system, a case when a pause section (silence for a predetermined time which occurs immediately after stopping or ending the uttering) is detected in the voice PCM data of the speaker, or a case when a value indicating that the speaker is switched is detected by the speaker diarization processing module 161. In the meantime, in order to obtain high quality translation data, a beginning and an end of the sentence are preferably exact but a beginning and an ending of the sentence which is uttered by the speaker in the system are not necessarily exact. If an additional job is performed in order to obtain a high quality translation result, a specific voice recognition quality improving method may be applied.

As the voice recognition quality improving method, for example, when the speaker is switched, the voice recognizing module 163 sets a voice of the speaker which is previously uttered as an end section and a voice PCM frame of a switched speaker as a uttering starting section. When a boundary of a sentence such as a final ending of Korean is estimated in a language, the voice recognizing module 163 may repeatedly recognize the voice whenever the pause section appears in the voice PCM data. The voice recognizing module 163 recognizes until a termination ending appears in the converted text as a sentence boundary and returns a voice recognition result with a shape which is estimated as a complete sentence. The voice recognizing module 163 utilizes an N-gram language model (LM) having the beginning and the ending of the sentence as features to repeatedly recognize the voice until a section in which the termination code is estimated to be generated appears in the voice recognizing result.

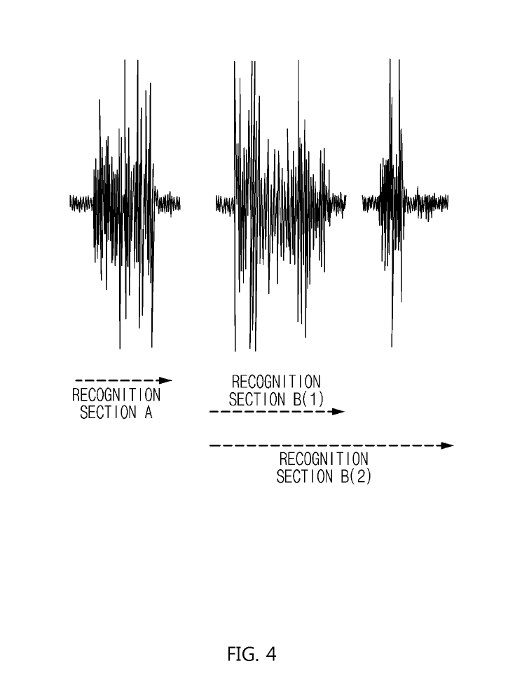

FIG. 4 is a view illustrating a clustering operation per speaker according to an exemplary embodiment of the present invention.

Referring to FIG. 4, it is assumed that a voice PCM input for a specific speaker X enters to be divided by sections by the speaker diarization processing module 161. In the case of a voice PCM input which is classified as a recognition section A, it is clearly notified that a time when the speaker is switched occurs next to the recognizing section A by the speaker diarization processing module 161, the speaker based clustering module 162 may clearly recognize the beginning and the ending of the voice input. As a result, the speaker based clustering module 162 transmits the recognizing section where the beginning and the ending are clear to the voice recognizing module 163 to clearly recognize the sentence.

In the meantime, when the recognizing section is not continuous and a voice input enters with an unclearly divided frame, the speaker based clustering module 162 notices that the voice PCM data corresponding to a recognizing section B(1) which is transmitted by the speaker diarization processing module 161 ends with an incomplete sentence. For example, the speaker based clustering module 162 may obtain an incomplete sentence saying “when a weight of a total budget is examined”. In this case, the speaker based clustering module 162 may control to perform voice recognition by adding two voice PCM input frames to one, like a recognizing section B(2) through a process of recognizing the termination ending or a termination code. Accordingly, the voice recognizing module 163 may output a correct voice recognition result saying that “when a weight of a total budget is examined, 20% thereof corresponds to initial business cost”, for example.

The voice recognizing module 163 recognizes the voice PCM data as a voice to create a text. The voice recognizing module 163 may return a text together with an estimated original language (for example, English, Chinese, Korean). The text which is created by the voice recognizing module 163 may be transmitted to the automatic translating module 164 in accordance with the setting. A technology which is applied to the voice recognizing module 163 may use any type of technology which is developed based on an existing technology. Such a voice recognizing module 163 receives the voice PCM data as an input to support to return the voice PCM data as a text (a string) of a specific language corresponding to the voice PCM data.

The automatic translating module 164 utilizes an original language hint (for example, Chinese) which is returned by the voice recognizing module 163 to return a text which is translated by a translated language (for example, Korean) which is designated by the user in advance. The automatic translating module 164 may transmit the unique ID of the speaker which enters as an input to the speaker based output processing module 165 together with the voice recognizing result and the translation result. As the automatic translating module 164, any system which is implemented by a rule based machine translation or statistical machine translation which is developed based on the existing technology or a technology method in which the translation is mixed may be used. The automatic translating module 164 may translate a set translated language or an input source language. For example, when a text which is returned through the voice recognizing module 163 is configured as follows and Korean is set as an original sentence and English is set as a translated language, the automatic translating module 164 may output a specific result. Specifically, the automatic translating module 164 according to an exemplary embodiment of the present invention may perform automatic translation based on the clustered result.

For example, in the case of an input that a whole sentence which is desired by the speaker is not completed is actually translated, a meaning thereof may be different from an original meaning when the translation is performed. For example, when a Korean original sentence is input as “ [symbol] [symbol] [symbol] ”, a translation result may be output as “We understand well about this point.” in English. The automatic translation operating device 100 according to the exemplary embodiment of the present invention may cluster and output a complete sentence. For example, a complete original sentence input of “ [symbol] [symbol] [symbol] [symbol] .” in Korean is clustered and created and the automatic translating module 164 may output a result of “We are understanding well about this point” in English.

When boundaries of a sentence overlap, that is, when one or more ending codes are included in the voice recognition result or a sentence after the ending code appears, sentences before and after the ending code are segmented to be represented as two sentences. When the Korean original sentence input is “ [symbol] [symbol] [symbol] [symbol] [symbol] ” in accordance with the clustering operation of the speaker based clustering module 162, the automatic translating module 164 of the automatic translation operating device 100 according to an exemplary embodiment of the present invention may output a translation result saying that “It is there. Moreover, I am thinking of the additional budgeting”. When the user interacts with an interface which is provided by the automatic translation operating device 100, the sentence may be corrected using an interface which readjusts the sentence recognizing section. When there is no separate interaction, the translation is performed as described above and the result may be returned.

The speaker based output processing module 165 classifies the voice recognizing result or the automatic translation result by user IDs. The unique user IDs may be distinguished depending on the user and a unit which identifies a specific user by a secondary unit (a portable automatic translation terminal or a smart phone which is possessed by speakers who simultaneously participate) may be utilized. The speaker based output processing module 165 may output the text on a screen through the display module 140 and the speaker based output processing module 165 may support to transmit the text to a text-to-speech (TTS) module 166 to convert the text into voice PCM data and then output the voice PCM data to the audio module 130 in addition to a method of outputting the text on the display module 140. The speaker based output processing module 165 accepts a unique ID of a speaker which is received as an input, the transmitted text result, and an original sentence recognizing result to represent the ID and the results as an expression method which may recognize the difference in speakers. The output may be represented through the display module 140 or the audio module 130 to the user. If the unique ID of the speaker and information on a specific user in a computing device which is being used are disposed one by one, the unique ID may be represented together with the user information by utilizing the information in the computing device or information which is input in the system. When a main user controls a setting to listen to the translation result of the specific speaker as a voice, the speaker based output processing module 165 may support to transmit the translation result of a specific speaker to the TTS module 166 to convert the translation result into the voice PCM data and output the data through the audio module 130.

The TTS module 166 may convert at least one of the voice recognizing result and the translation result into audio data. The TTS module 166 may transmit the converted audio data to the audio module 130. Such a TTS module 166 may convert a text corresponding to a voice signal of at least one of specific speakers which is designated while the automatic translation operating device 100 according to an exemplary embodiment of the present invention is operated into audio data. Here, the text may be a voice recognized result or a translated result.

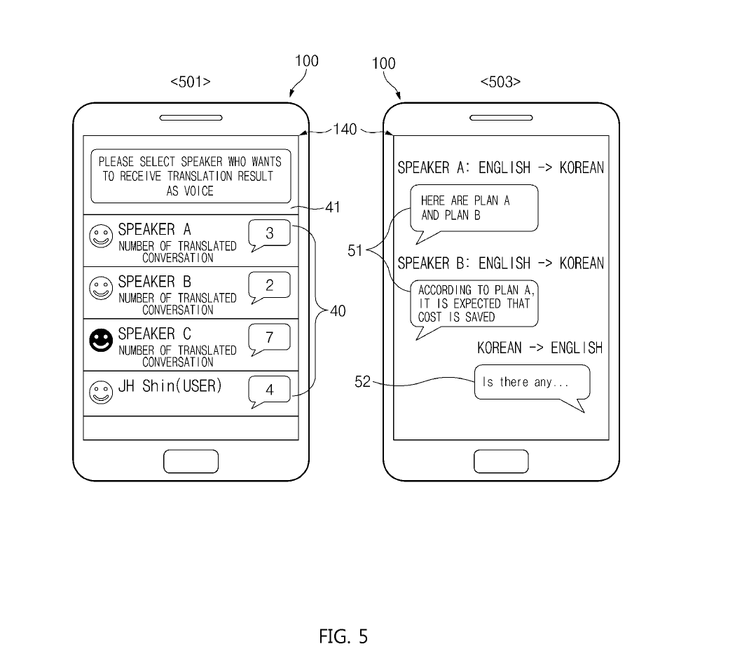

FIG. 5 is a view illustrating an example of a screen interface of an automatic translation operating device according to an exemplary embodiment of the present invention.

Referring to FIG. 5, the automatic translation operating device 100 may provide an example situation which is distinguished by the speaker based output processing module 165 to a screen interface which has a messenger type configuration on a portable computing terminal having a small screen such as a smart phone.

The automatic translation operating device 100 may classify the voice signals by speakers when voice signals are input from a plurality of speakers. Therefore, the display module 140 of the automatic translation operating device 100 may output information on classified speakers like a screen 501. For example, when four speakers are classified, the automatic translation operating device 100 may output items corresponding to four classified speakers as illustrated in FIG. 5. To this end, the automatic translation operating device 100 may operate four voice input devices 110 or collect voice input signals which are uttered by four speakers through one voice input device 110. Alternatively, the automatic translation operating device 100 may be connected to three different electronic devices through the communication network 200 and receive voice signals which are collected and transmitted by three different electronic devices through one voice channel. The automatic translation operating device 100 may classify the voice signals by speakers based on voiceprints of the speakers and output information on the classified speakers on the display module 140 as illustrated by 501. Specifically, the display module 140 may provide a screen for selecting a speaker who hopes to listen to a translated audio signal of the voice recognized result. To this end, the display module 140 may provide a guide area 41 which displays a guide to select a speaker and a speaker selecting area 40. When a speaker C who wants to listen to the translation result as a voice as illustrated in the screen 501 is selected, the automatic translation operating device 100 may output a screen corresponding thereto. For example, the display module 140 may display the corresponding item on the screen to be inversed in order to notify that the “speaker C” is selected. When contents which are uttered by the speaker C are recognized as a voice and a translated result is calculated, the automatic translation operating device 100 may output the result as an audio signal through the TTS module 166.

In the meantime, the automatic translation operating device 100 may sequentially output the voice recognizing result or the translation result 51 corresponding to uttering of several speakers on a screen as illustrated in a screen 503. Here, the automatic translation operating device 100 may also output the content 52 uttered by the selected speaker who wants to listen as the audio signal on the screen.

Such an interface configuration may vary depending on various restrictions such as a size of the screen or a system. Even though the present invention does not specifically define the interface, according to the configuration of the exemplary embodiment of the present invention, the voice recognition result of the speakers and the translation result may be represented on a screen, as a voice or a text by the speaker based output processing module 165.

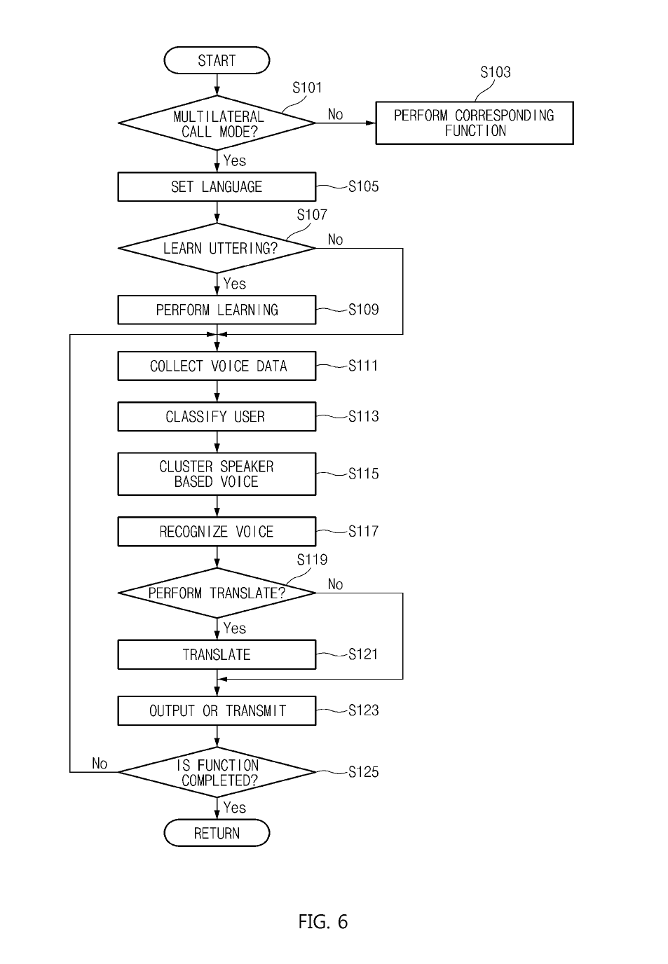

FIG. 6 is a diagram illustrating a multilateral automatic translating method according to an exemplary embodiment of the present invention.

Referring to FIG. 6, according to the multilateral automatic translating method according to an exemplary embodiment of the present invention, the control unit 160 of the automatic translation operating device 100 may confirm whether to be in a multilateral call mode or whether an input event for entering a multilateral call mode occurs in step S101. In this step, when the mode is not the multilateral call mode or an input event for performing a specific function occurs, the control unit 160 may support to perform a specific function corresponding to the input event of the automatic translation operating device 100 in step S103. For example, the automatic translation operating device 100 may perform a file reproducing function, a file searching function, and a broadcasting receiving function in accordance with a module which is installed in the device.

In the meantime, when the mode is the multilateral call mode or an event for performing the multilateral call mode occurs in step S101, the control unit 160 may support to set a language in step S105. The control unit 160 may output a language setting screen on the display module 140 in order to support to set a language. When an input event for setting a language occurs, the language may be set as a default language. The language which is set during a language setting process may be a language which is applied during a translating process. In the meantime, when there is a default setting related with the language setting, the control unit 160 may skip step S105 while maintain the default setting.

Next, the control unit 160 may check whether an event for executing uttering learning occurs in step S107. In this step, the control unit 160 may determine whether to select a predefined menu item or a menu icon for executing the uttering learning or whether to execute the uttering learning in accordance with schedule information which is set in advance in order to execute the uttering learning. When there is an event or schedule information for executing the uttering learning in step S107, the control unit 160 may perform the uttering learning in step S109. In the meantime, if there is no event or schedule information for uttering learning, the control unit 160 may skip step S109.

Next, the control unit 160 may collect voice data in step S111. The process of collecting voice data may be a process of collecting a voice signal which is input by speakers in a plurality of voice input devices 110. Alternatively, the process may be a process of receiving the voice signal input by the speakers from the plurality of electronic devices which is connected through the communication network 200.

In step S113, the control unit 160 may classify users. During this process, the control unit 160 may distinguish a type of speaker using a voiceprint per speaker. Further, the control unit 160 may classify the speakers using the voice input devices 110 which collect the voice signals or the electronic devices which transmit the voice signals as index values.

In step S115, the control unit 160 may perform voice clustering per speaker. When the classification per speaker is performed, the control unit 160 may perform clustering until the voice signals become a complete sentence. During this process, the control unit 160 may inspect whether the received voice signal has a termination ending or a termination code.

In step S117, voice is recognized. When the termination ending or the termination code is searched, the control unit 160 may recognize a voice for a clustered voice signal per speaker. To this end, the automatic translation operating device 100 may include a voice recognition database. When the speakers speak various languages, the voice recognition database may include a voice recognition database per language.

In step S119, the control unit 160 may check whether there is schedule information for performing translation or an event for performing the translation occurs. When the event for performing the translation occurs or the schedule information is provided, the control unit 160 bifurcates to step S121 to perform the translating function. During the translating process, the control unit 160 may translate the voice recognized text result into a set language. To this end, the automatic translation operating device 100 may include a translation database corresponding to the set language. In the meantime, when an event of executing the translation does not occur or schedule information is not provided, the control unit 160 may skip step S121.

Next, the control unit 160 bifurcates to step S123 to output or transmit at least one of the voice recognized result and the translation result. To be more specific, the control unit 160 may output the text which is output as the voice recognized result or the translated result by speakers on the display module 140 so as to distinguish the text by speakers. Further, the control unit 160 may control to convert a text of a specific designated speaker among the output texts into an audio signal and output the audio signal through the audio module 130. Alternatively, the control unit 160 may control to convert the output text into the audio signal and output the converted audio signal through the audio module 130. In this case, the control unit 160 outputs the output text so as to be distinguished by speakers.

Next, the control unit 160 may check whether an event for completing a function occurs in step S125. In this step, when there is no event for completing a function, the control unit 160 bifurcates before step S111 to support to re-perform the processes before step S111. In the meantime, when an event for completing a function occurs in step S125, the control unit 160 bifurcates before step S101 to support to re-perform the processes before step S101.

As described above, the multilateral automatic translation operating device and method according to the exemplary embodiment of the present invention may classify the voice signal uttered by a plurality of speakers per speaker and perform the clustering until a completed sentence condition is satisfied, and then perform the voice recognition and translation. Therefore, the multilateral automatic translation operating device and method according to the exemplary embodiment of the present invention may support to perform correct voice recognition and translation within a range where no meaning is changed.

While the exemplary embodiments of the present invention have been described for illustrative purposes, it should be understood by those skilled in the art that various changes, modifications, substitutions, and additions may be made without departing from the spirit and scope of the present invention as defined in the appended claims and it should be understood that such changes and modification are covered by the following claims.

What is claimed is:

1. An automatic translation operating device, comprising:
at least one of voice input devices which collects voice signals input by a plurality of speakers and a communication module which receives the voice signals; and
a control unit which controls to classify the voice signals by speakers and cluster the speaker based voice signals classified in accordance with a predefined condition and then perform voice recognition and translation.

2. The device of claim 1, wherein the control unit classifies the voice signals by speakers using the voice input device which collects the voice signals and electronic devices which transmit the voice signals as indexes.

3. The device of claim 2, wherein the control unit performs learning for distinguishing a voiceprint per speaker.

4. The device of claim 3, wherein when a voice signal of the voiceprint other than a speaker who is distinguished in advance is input, the control unit determines the speaker as a new speaker.

5. The device of claim 1, wherein the control unit performs clustering until a sentence termination ending or a sentence termination code is searched in the speaker based voice signal.

6. The device of claim 5, wherein the control unit performs translation on a complete sentence which is distinguished by the sentence termination ending or the sentence termination code.

7. The device of claim 1, further comprising:
a display module which outputs the speaker based voice recognition and translation result.

8. The device of claim 1, wherein the control unit converts a translation result corresponding to a specific voice signal designated among the speaker based voice signals into an audio signal.

9. The device of claim 8, further comprising:
an audio module which outputs the audio signal.

10. An automatic translation operating method, comprising:
collecting voice signals which are input by a plurality of speakers;
classifying the voice signals by speakers from the voice signals;
clustering the speaker based voice signals which is classified in accordance with a predefined condition; and
recognizing and translating the clustered voice signals as a voice.

11. The method of claim 10, wherein the collecting includes collecting the voice signals using at least one of voice input devices and a communication module.

12. The method of claim 10, wherein the classifying includes classifying the voice signals by speakers using the voice input device which collects the voice signals and electronic devices which transmit the voice signals as indexes.

13. The method of claim 12, further comprising:
performing learning for distinguishing a voiceprint per speaker.

14. The method of claim 13, wherein the classifying includes when a voice signal of a voiceprint other than that of a speaker who is distinguished in advance by performing the learning is input, determining the speaker as a new speaker.

15. The method of claim 10, wherein the clustering includes:
searching a sentence termination ending or a sentence termination code in the speaker based voice signal; and
recognizing a section where the sentence termination ending or the sentence termination code is searched as a complete sentence.

16. The method of claim 15, wherein the translating includes performing translation on a complete sentence which is distinguished by the sentence termination ending or the sentence termination code.

17. The method of claim 10, further comprising:
outputting the speaker based voice recognition and translation result.

18. The method of claim 10, further comprising:
converting a translation result corresponding to a specific voice signal designated among the speaker based voice signals into an audio signal; and
outputting the audio signal.

19. An automatic translation operating system, comprising:
a plurality of electronic devices which collects and transmits voice signals input by a plurality of speakers; and
an automatic translation operating device which controls to classify the voice signals by speakers from the voice signals transmitted by the electronic devices and cluster the speaker based voice signals classified in accordance with a predefined condition and then perform voice recognition and translation.

20. The system of claim 19, wherein the automatic translation operating device performs the clustering until a sentence termination ending or a sentence termination code is searched in the speaker based voice signal and recognizes, translates, and outputs the clustered signal as a voice.
